(19) United States
(12) Patent Application Publication
(10) Pub. No.: US 2006/0183816 A1
(43) Pub. Date: Aug. 17, 2006

(54) Additive system for use in paper making and process of using the same

(76) Inventors: Robert Alan Gelman, Newark, DE (US); Brian Watson Ranson, Greensboro, NC (US)

Correspondence Address: Gary A. Samuels;Hercules Incorporated, Hercules Plaza, 1313 North Market Street, Wilmington, DE, 19894-0001, US

(21) Appl. No.: 11/056,045

(22) Filed: Feb. 11, 2005

(51) Int. Cl. C09D 151/00; D21H 23/00

(52) U.S. Cl. 523/201; 162/158; 162/181.1; 162/181.2; 162/181.3; 162/181.4; 162/181.8; 162/164.1

(57) ABSTRACT

The embodiments of the present invention relate to an additive system comprising a cationic latex and an anionic polymer; as well as a process utilizing the additive system for making paper where the process is effective in all grades of paper, particularly those grades used for printing and writing.

### FIELD OF THE INVENTION

The present invention relates to embodiments of an additive system and process for using the additive system in making paper containing fillers as well as making paper without any filler.

### BACKGROUND OF THE INVENTION

Pulp or wood pulp is the result of a process where the fibers of wood, or other plant materials, are separated for use in the manufacture of paper. Pulping, the process by which the pulp is prepared, can involve chemical and/or mechanical means.

Mechanical pulping utilizes grinding or similar physical processes to reduce the wood into fibers of a desired size. Mechanical processes are not designed to selectively remove specific chemical constituents from wood, and, thus, does not alter the chemical constituents of the material. Examples of mechanical processes include grinding, such as stone ground wood, and thermomechanical pulping.

Chemical pulping, in contrast, is the selective removal of material from the wood to increase the relative amount of cellulose. Lignin, a fiber bonding material, and soluble polysaccharides, such as hemicelluloses and pectins, are removed in chemical pulping processes. Example of chemical pulping process include the Kraft and sulfite processes.

Additionally, there are a number of pulping processes that combine chemical and mechanical means, referred to as chemimechanical processes. These processes, which include the cold soda and sodium bisulfite processes, involve chemical pretreatment of the wood prior to mechanical refining, do not yield a wood free pulp.

It is noted that chemical pulping does include mechanical action, but the key differentiation is the key role of chemical reactions that selectively remove specific chemical moieties. A detailed review of pulping can be found in PULP AND PAPER: Chemistry and Chemical Technology, Third Edition, J. P. Casey, ed., Wiley-Interscience, New York, 1980, Volume 1, Pages 161-631.

The above-described processes may be mechanically or chemically manipulated to affect the properties of the resulting paper. However, the paper itself can also be manipulated to affect its properties by the use of various additives.

Paper is not typically comprised of 100% cellulose fibers, but will contain a number of additives to provide specific properties and/or reduce the overall cost of the paper. These materials can be organic or inorganic in nature. Moreover, they can be water-soluble, water-swellable, water-compatible, or water-insoluble.

Examples of organic materials may include, but are not limited to, sizing agents, such as rosin, alkylketene dimer, and alkenyl succinic anhydride; strength additives, such as polyamidoamine epichlorohydrin resins and copolymers of acrylamide; and retention and drainage aids, such as anionic or cationic copolymers of acrylamide. Other additives, such as dyes and optical brighteners, are used in certain grades of paper.

Inorganic materials include, but are not limited to, mineral compositions, such as alumina, clay, calcium sulfate, diatomaceous silica, silicates, calcium carbonate, silicas, silicoaluminates, talc, and titanium dioxide. Inorganic materials are often used as fillers, where they provide a reduction in material costs, for most fillers cost less than the fiber.

The addition of almost any substance, including fillers, to the fibrous furnish reduces paper strength by reducing fiber bonding. It is the fiber-to-fiber bond formed when the sheet is dried after formation that provides paper with its unique mechanical properties. Paper cannot be made unless there is a high degree of bonding between the fibers. Without this interfiber bonding, the paper would disintegrate when any amount of force is applied. Interfiber hydrogen bonds that form as a natural result of drying the paper sheet depend on close physical contact between two fibers. Addition of other materials such as fillers, particularly those that are not water soluble and are of discrete physical size, can prevent or limit the extent of fiber to fiber association by physically preventing contact between the fibers. As the number of particles increases, the amount of interfiber association decreases. For example, with respect to two surfaces that are to be adhered to one another, the area of the contact between the surfaces determines the strength of the adherence. Thus, the greater the area of contact between the surfaces the greater the adhesive bond. However, when a particle, such as sand, is present between the two surfaces, the overall area of contact between the two surfaces is lessened, thereby resulting in reduced strength.

Thus, the presence of filler can result in an increase of certain properties. The addition of fillers can also result in a decrease in key structural parameters, such as tensile strength and stiffness, and therefore such adverse impacts have limited their use.

### SUMMARY OF THE INVENTION

Briefly described, embodiments of the present invention relate to an additive system, as well as their use in paper making processes, for making paper containing a filler as well as paper that does not contain any filler.

Other processes, methods, features and advantages of the embodiments of the present invention will be or become apparent to one skilled in the art upon examination of the following drawings and detailed description. It is intended that all such additional processes, methods, features and advantages be included within this description, be within the scope of the present invention, and be protected by the accompanying claims.

### DETAILED DESCRIPTION

The making of cellulosic fiber sheets, particularly paper and paperboard, typically comprises: 1) producing an aqueous slurry of cellulosic fiber (a.k.a. pulp or wood pulp) which may also contain inorganic mineral extenders or pigments; 2) depositing the slurry on a moving papermaking wire of fabric; and 3) forming a sheet from the solid components of the slurry by draining the water. The foregoing is followed by pressing and drying the sheet to further remove water. Organic and inorganic chemicals are often added to the slurry prior to the sheet-forming step (step 3) to make the papermaking method less costly, more rapid, and/or to attain specific properties in the final paper product.

As used herein, the terms “paper” and “paperboard”, are generally considered here to be equivalent, and typically refer to non-woven mats of cellulose fibers prepared from an aqueous slurry of pulp and other materials. The differentiation of the two terms is typically based on the thickness or weight of the sheet, with the thicker or heavier sheets termed paperboard or board. The weight of a sheet of paper is termed basis weight or grammage.

The embodiments of the present invention are directed to an additive system (also referred to herein as a “CL/AP system”) for paper making and its use in a process for making paper; wherein the additive system is effective in all grades of paper, preferably those grades used for printing and writing. Additionally, of particular interest are paper grades termed free sheet or wood free sheet, which refer to the wood pulp used to make the paper not containing any groundwood fiber or other fibers derived from wood that have not been chemically pulped.

An embodiment of the present invention relates to an additive system comprising a combination of a cationic latex and an anionic polymer. Typically, the cationic latex and anionic polymer are each contained in an aqueous medium, such that they are introduced into the papermaking process in the form of a solution, dispersion or emulsion.

Another embodiment of the present invention contemplates a paper sheet comprising embodiments of the additive system.

Another embodiment of the present invention is a process for making paper, comprising:

(a) producing an aqueous slurry of cellulosic fibers; and

(b) adding an additive system comprising:
(i) adding a cationic latex to the aqueous slurry, and
(ii) adding an anionic polymer to the aqueous slurry.

The embodiments of the present invention contemplate the above-described process further comprising:

(c) forming a paper sheet.

Generally, the embodiments of the present invention use a combination of a cationic latex and an anionic polymer in order to allow highly filled (greater than 15 wt-%) paper sheets to exhibit properties such as, for example, physical, mechanical and optical properties similar to that of a sheet containing up to 50% less filler. While the embodiments of the present invention may be utilized with paper containing no filler, when filler is present, its amount ranges from about 5 wt-% to about 60 wt-% and preferably ranging from about 15 wt-% to about 50 wt-%, more preferably ranging from about 20 wt-% to about 40 wt-%, most preferably ranging from about 25 wt-% to about 40 wt-% of the final paper sheet.

Generally, the term “latex” refers to an aqueous dispersion of a water-insoluble polymer. The polymer can be composed of a single monomer, resulting in a homopolymer, or two or more different monomers, resulting in a copolymer. Latex materials are typically prepared in an emulsion polymerization process wherein the insoluble monomer is emulsified, typically with a surfactant, into small particles of less than about 10,000 nm in diameter in water and polymerized using a water-soluble initiator. The resultant product is a colloidal suspension of fine particles, preferably about 50 nm to about 1000 nm in diameter. Latex applications include, but are not limited to, use in adhesives, binders, coatings, and as modifiers and supports for immobilization of other materials. A review of latex chemistry can be found in the Kirk-Othmer Encyclopedia of Chemical Technology, Fourth Edition, Wiley —Interscience, New York, 1995, Volume 15, Pages 51-68.

A latex material typically has an effective charge, which is often a consequence of the surfactants and other additives used in the preparation of the material. Thus, the use of an anionic surfactant as the emulsifier will result in an anionic latex. Non-ionic surfactants may also be used, thereby resulting in a latex particle with a very small, or no, effective charge. A monomer that has a charged functional group may contribute to the overall charge of the latex particle. The latex for use in the embodiments of the present invention is typically a cationic latex material; however, such materials are not readily available. Therefore, anionic latex or nonionic latex typically undergo a modification to form a cationic latex. However, a pre-made cationic latex may be produced or obtained commercially where the modification procedures described herein would be unnecessary.

The modification or treatment of the anionic or nonionic latex results in a change in the zeta potential, which is a measure of the magnitude of the repulsion or attraction between particles. It is a useful indicator of the electronic charge on the surface of a particle and can be used to predict and control colloidal suspensions or emulsions. The higher the absolute value of the zeta potential, the more likely the suspension is to be stable, as repulsion of the like charges will overcome tendencies of the latex particles to aggregate. Zeta potential is a controlling parameter in processes such as adhesion. Therefore, an anionic latex or nonionic latex is typically modified to result in a latex having an effective cationic charge. An effective cationic charge is preferred as it provides for an affinity to the anionic surface of the cellulose fiber. The zeta potential may be measured using a Zeta Plus zeta potential analyzer (Brookhaven Instrument Corporation, Holtsville, N.Y.). For example, the zeta potential for Airflex 4530, an ethylene vinyl chloride latex, produced by Air Products Polymers (Allentown, Pa.) is −32.6 mV. Treatment with Kymene 557H resin (available from Hercules, Inc., Wilmington, Del.), by the method described herein, at a 1.67:1 ratio of polymer to latex, changes the zeta potential of the particle to +29.7 mV.

If the initial latex is anionic or nonionic, the cationic charge may be achieved by use of a cationic polymer that is absorbed onto the surface of the latex particle. The cationic polymers are water soluble and contain cationic functional groups, wherein an example of preferred cationic functional groups are cyclic quaternary groups. The latices are modified by the addition of the cationic polymer, where the cationic polymer is deposited onto the latex surface, thereby rendering the latex surface cationic. Thus, the effective charge of the particle can be modified in a similar manner to that disclosed by U.S. Pat. No. 5,169,441 (Lauzon), which is incorporated herein by reference in its entirety.

Suitable latices of anionic or nonionic latex capable of undergoing modification can be identified based on physical properties using standard methodologies, including stability, rheology, thermal properties, film formation and film properties, interfacial reactivity, and substrate adhesion. The properties are determined by the chemical, colloidal and polymeric properties of the latex. Colloidal properties include particle size distribution, particle morphology, solids, pH, viscosity, and stability. Key chemical and physical properties such as molecular weight and molecular weight distribution, chemical structure of the monomer(s), monomer sequence and distribution, and glass-transition temperature are typical characteristics and are well known in the art.

Commercially available latices are derived from a large variety of monomers, including, but not limited to, styrene, butadiene, dimethylstyrene, vinyltoluene, chloroprene, ethylene, propylene, butene, acrylamide, acrylonitrile, acrolein, methylacrylate, ethylacrylate, acrylic acid, methacrylic acid, methyl methacrylate, n-butyl acrylate, vinylidene chloride, vinyl ester, vinyl chloride, vinyl acetate, acrylated urethane, hydroxyethyl acrylate, dimethylaminoethyleneacrylate, and vinyl acetate. Other examples of the latex material preferably include, but are not limited to, copolymers of alkyl halides and alkene halides, such as copolymers of vinyl or allyl halides and alkenes. Standard textbooks, such as Organic Chemistry, Morrison and Boyd, Allyn and Bacon, Inc., 1973, list exemplary materials.

Non-limiting examples of the preferred cationic functional groups include amine, quaternary amine, epoxy azetidinium, aldehyde, and derivatives thereof, acrylamide base and derivatives thereof, more preferably azetidinium, epoxy, and aldehyde, and most preferably azetidinium and epoxy. Moreover, combinations of cationic functional groups may be utilized such as, for example, epoxy and azetidinium (e.g. KYMENE® 736 polyamine resin).

Non-limiting examples of cationic polymers for modifying an anionic or nonionic latex include polyamidoamine-epihalohydrin resins, acrylamide-based crosslinkable polymers, polyamines, and polyimines. Preferred cationic polymers include, but are not limited to, polyamidoamine-epihalohydrin resins such as those disclosed in U.S. Pat. Nos. 2,926,116 and 2,926,154, to KEIM (which is incorporated by reference herein in its entirety), and cationic functionalized poly-acrylamides (HERCOBOND® 1000 manufactured by Hercules Incorporated, Wilmington, Del.) such as those disclosed in U.S. Pat. No. 5,543,446 and creping aids such as CREPETROL® A 3025 disclosed in U.S. Pat. No. 5,338,807 (each of which is incorporated by reference herein in its entirety). The preferred polymidoamine-epihalohydrin resins such as those disclosed in U.S. Pat. Nos. 2,926,116 and 2,926,154, to KEIM, each of which is incorporated by reference herein in its entirety. Preferred polyamidoamine-epihalohydrin resins can also be prepared in accordance with the teachings of U.S. Pat. No. 5,614,597 to BOWER (which is incorporated by reference herein in its entirety) and commonly assigned to Hercules Incorporated. Other suitable materials include polymers or copolymers of diallyidimethylammonium chloride, known as DADMAC, and polyamines-epichlorohydrin resins, such as copolymers of dimethylamine and epichlorophydrin. Moreover, various combinations of the polymers may be utilized in the embodiments of the present invention.

Preferred commercially available polyamidoamine-epihalohydrin resins include, but are not limited to, the KYMENE® resins (e.g. KYMENE® 557H resin; KYMENE® 557LX2 resin; KYMENE® 557SLX resin; KYMENE® 557ULX resin; KYMENE® 557ULX2 resin; KYMENE® 736 resin) and the HERCOBOND® resins (e.g., HERCOBOND® 5100 resin), all of which are available from Hercules Incorporated of Wilmington, Del. Of these, KYMENE® 557H resin and HERCOBOND® 5100 are especially preferred polyamidoamines, available in the form of aqueous solutions. KYMENE® 736 polyamine resin can also be employed.

As shown in the Examples, typically, an aqueous cationic polymer solution is formed, and thus combined with the anionic or non-ionic latex to result in a cationic latex, where the cationic polymer and anionic or nonionic latex in a weight ratio ranging from about 0.02:1 to about 10:1, preferably ranging from about 0.02:1 to about 0.75:1, more preferably ranging from about 0.25:1 to about 0.5:1 (based on the polymer/latex (active) material. Although the cationic latex may be prepared either by adding the anionic or nonionic latex to the aqueous cationic polymer solution or the addition of the aqueous cationic polymer solution to the anionic or nonionic latex, the former is preferred.

The anionic polymer can be any water-soluble, water-dispersible or water swellable anionic material or polymer with an effective anionic charge. Non-limiting examples of suitable anionic polymers include those made from anionic monomers, including but not limited to, the free acids and salts of acrylic acid and combinations thereof, styrenesulfonate, maleic acid, itaconic acid, methacrylic acid, 2 acrylamido-2-methyl-1-propane sulfonate acid, vinyl sulfonic acid, vinylphosphonic acid, acrylamidologycolic acid and combinations thereof.

Copolymers of two or more monomers can also be used in the embodiments of the present invention. In addition, the copolymer may comprise one or more anionic monomer as well as one or more non-ionic monomer.

Non-limiting examples of suitable nonionic monomers include, but are not limited to, acrylamide, methacrylamide; N-alkylacrylamides, such as N-methylacrylamide; N,N-dialkylacrylamide, such as N,N-dimethylacrylamide; methyl acrylate; methyl methacrylate; acrylonitrile; N-vinyl methylacetamide; N-vinyl methyl formamide; vinyl acetate; N-vinyl pyrrolidone, alkyl acrylates, alkyl methacrylates, alkyl acryamides, alkyl methacrylamides, and alkyloxylated acrylates and methacrylates such as alkyl polyethyleneglycol acrylates, and alkyl polyethyleneglycol methacrylates. A non-limiting example of a preferred anionic/nonionic copolymer is an acrylic acid/acrylamide copolymer.

In the embodiments of the present invention, the combination of the cationic latex and the anionic polymer is used to produce the desired improvement in the properties of the paper.

Thus, the additive system is typically utilized where the cationic latex and the anionic polymer are present in a weight (dry actives) ratio ranging from about 0.03:1 to about 10:1; preferably ranging from about 0.05:1 to about 4:1 and more preferably ranging from about 1:1 to about 3:1, and most preferably ranging from about 1:1 to about 2:1.

The addition points for the additive system embodiments can be varied to suit the specific construction of the paper machine and such addition points can be varied without a negative effect on performance. Skilled artisans would recognize and understand the suitable points of addition for those machines known in the art. Typically, the point of addition of the additive system embodiments is the point of the paper making process providing the greatest efficacy, the least amount of impact on any other additives present and the easiest point of addition. For example, most preferably in a commercial Fourdrinier paper making machine, the cationic latex was added after the machine chest and prior to the point where the alum, filler and sizing agents may be added.

The embodiments of the additive system may be added to the papermaking process either separately or as a pre-mix, however separate addition is preferred. Typically, the addition of the cationic latex precedes the addition of the anionic polymer, however, the anionic polymer may be added prior to the cationic latex.

The additive system may be added to the aqueous slurry of pulp in an amount ranging from about 5 lb/ton of pulp to about 100 lb/ton of pulp, preferably ranging from about 15 lb/ton of pulp to about 50 lb/ton of pulp; more preferably ranging from about 20 lb/ton of pulp to about 40 lb/ton of cationic latex and anionic polymer per ton of dry paper.

### EXAMPLES

All parts and percentages are by weight unless noted otherwise.

Preparation of Cationically Modified Latex

Add 271.5 g of Kymene® 557H, a product of Hercules Incorporated, Wilmington, Del., to 327.5 g of distilled water and stirred for 10 minutes, followed by the addition of 5.0 g of 50% sodium hydroxide solution to the solution to raise the pH from 5.1 to 11.1. Then, add 264.25 g of Genflo® 2553, a product of Omnova Solutions Inc., Fairlawn, Ohio, to the polymer solution with mixing; stir for a period of 15 minutes. Then, 1.85 g of sulfuric acid (93%) is added to the vortex of the stirred solution to adjust the pH of 4.5 to 4.8. Then 130 g of aluminum sulfate (38.5% solution) is added to the stirred solution, with stirring continued for an additional 15 minutes. The material is then filtered through a 100 US mesh screen.

Latex materials were prepared as noted above, using different a starting latex and ratio of resin to latex. All Genflo® (styrene butadiene (SBR)) latex samples were obtained from Omnova Solutions Inc., Fairlawn, Ohio. The material used in this work is described in Table 1.

TABLE 1
MODIFIED LATEX MATERIALS

| Latex | Latex | Resin to Latex Ratio |
|---|---|---|
| 1 | Genflo 2553^{(a)} | 0.3:1 |
| 2 | Genflo 2553^{(a)} | 0.65:1 |
| 3 | Genflo 2553^{(a)} | 1:1 |
| 4 | Genflo 3060^{(b)} | 0.3:1 |
| 5 | Genflo 3060^{(b)} | 0.65:1 |
| 6 | Genflo 3060^{(b)} | 1:1 |
| 7 | Genflo 3003^{(c)} | 0.3:1 |
| 8 | Genflo 3003^{(c)} | 0.65:1 |
| 9 | Genflo 3003^{(c)} | 1:1 |

^{(a)}Latex T_{g} is −22° C.
^{(b)}Latex T_{g} is −22° C.
^{(c)}Latex T_{g} is −5° C.

Two anionic polymers were considered in this work. Polymer A is an acrylamide copolymer containing 8 mol % acrylic acid material marketed as Hercobond® 2000 (anionic functionalized poly-acrylamides) by Hercules Incorporated (Wilmington, Del.) and polymer B is an acrylamide copolymer containing 20 mol % acrylic acid polymer marketed by Hercules Incorporated as PPD M-5066.

Preparation of Paper

In the following examples, paper was made using a stock (a.k.a. wood pulp slurry) of a blend of hardwood and softwood bleached kraft pulps (70% Georgia Pacific bleached hardwood kraft and 30% Rayonier bleach softwood kraft) refined to a Canadian standard freeness (CSF) of 500 cc. The water of dilution was adjusted to contain 100 ppm hardness and 50 ppm alkalinity.

A pilot scale paper machine designed to simulate a commercial Fourdrinier was used, including stock preparation, refining and storage. The stock was prepared where a dry lap pulp was refined at 2.5% consistency (2.5% by weight of wood pulp) in a double disc refiner by recirculation until the desired freeness was reached. The stock was then pumped to a machine chest where it was diluted with fresh water to approximately 1.0% solids.

The stock was fed by gravity from the machine chest to a constant-level stock tank; the stock was then pumped to a series of in-line mixers (mix boxes) where wet end additives were added. After passing through the mix boxes, the stock entered the fan pump where further chemical additions could be made. The stock was diluted with white water at the fan pump to about 0.2% solids. The stock was pumped from the fan pump to a flow spreader and then to the slice, where it was deposited onto the 12-inch wide Fourdrinier wire. Immediately after its deposition on the wire, the sheet was vacuumed dewatered via two vacuum boxes.

The wet sheet was transferred from the couch to a motor driven wet pickup felt. The sheet was dewatered in a single-felted press and dried on dryer cans to 3-5% moisture. All additives were added to the pulp slurry before sheet formation.

The following materials were also used in the process of making the paper: Precipitated calcium carbonate (filler) was Albacar HO (Specialty Minerals, Bethlehem, Pa.), cationic starch was Stalok 400 (A. E. Staley Manufacturing, Decatur, Ill.), alkenyl succinic anhydride size was Prequel 1000 and Prequel 500 (Hercules Incorporated, Wilmington, Del.), alum (aluminum sulfate), and retention and drainage aids were PerForm™ PC8138 and PerForm™ SP9232 (Hercules Incorporated, Wilmington, Del.).

The chemical addition points can be varied to suit the specific construction of the paper machine. Addition points can be varied without a negative effect on performance. For this work, the cationic latex was added after the constant level stock tank and prior to the mix boxes where the alum, filler and sizing agents were added.

Properties Evaluated

In these examples, several properties were evaluated with respect to a paper sheet, including tensile strength, stiffness, bond strength, abrasion and porosity.

Strength is an important attribute of paper for the sheet must resist the effect of a variety of forces, both in production of the sheet and its use. While interfiber bonding is important to the strength of the paper sheet, a number of additives have been developed to enhance interfiber bonding. Chemicals have been used to increase the strength of paper. Some of these materials contain crosslinking functionalities. Tensile strength is a measure of the breaking load per unit of width of the sheet. As such, the time during which the force applied, the magnitude of the force, the size of the paper strip and other factors can affect the measurement. The tensile strength data was obtained using TAPPI method T-494. A high value for tensile strength is typically desirable.

Stiffness is a measure of the rigidity of a material. Stiffness is related to flow properties because it depends on the ability of the layer on the outside of the material to stretch and the ability of the inside layer to undergo compression. As the measurement can be influenced by test variations, the data is reported as Taber stiffness, using TAPPI method T-489. The desired stiffness level is dependent on paper use.

Fiber bonding, and thus the bond strength, has a significant effect on the end use of paper, particularly for printing where a paper sheet that does not have fiber removed from its surface during printing is desired. There are several approaches used in the paper industry to assess bond strength. The IGT printability tester is one method using a device designed to measure internal bonding and resistance to pick. Picking is related to bond strength. The tendency to pick increases with increasing speed of separation of ink and paper, thus, the speed at which picking first occurs is a measure of the pick resistance of the paper. A high value for IGT pick resistance is typically preferred. TAPPI method T-514 was used to measure IGT pick resistance.

Abrasion, or scuff resistance, is a measure of the surface strength of the sheet. A Taber abrader (using a horizontal turntable and an abrasive wheel) was used to determine the Taber abrasion. The amount of material abraded from the sheet after a set number of resolutions is determined. A low value is typically preferred. TAPPI method T-476 was used.

Paper is a highly porous material and a sheet contains as much as 70% air that fills pores, recesses and voids in the sheet. Air porosity is measured with a Gurley Densometer. The desirable porosity value will depend on the specific paper grade and use. Gurley porosity was measured by TAPPI method T-460. A detailed review of test methods for physical properties of paper can be found in PULP AND PAPER: Chemistry and Chemical Technology, Third Edition, J. P. Casey, ed., Wiley-Interscience, New York, 1981, Volume III, Pages 1715-1972.

Basis weight is the weight of a sheet of paper. It is the weight of a given area of paper, and is expressed as pounds per specific unit area; typically pounds per square feet. Common basis weight unit is pounds per 1000 square feet for board and pounds per 3000 square feet for papers used for printing and writing, although there are a number of different units used; all basis weight units are pounds per specific area. TAPPI method T-410 was used to measure basis weight. Grammage is used to describe the weight of paper in the metric system; the units are grams per square meter. Thickness, or caliper, is another important measurement of paper; it is measured in millimeters or thousandths of an inch. TAPPI method T-411 was used to measure caliper.

### Examples 1 to 4

Paper was prepared as described above, with filler content and additive levels shown in Table 2.

TABLE 2
EXAMPLES

| | Example | | | |
|---|---|---|---|---|
| | 1 | Comp. Ex. 2 | Comp. Ex. 3 | 4 |
| Filler(%)^{(a)} | 30 | 30 | 15 | 30 |
| Latex sample^{(b)} | 8 | — | — | 8 |
| Polymer^{(c)} | A | — | — | B |
| Latex:Polymer ratio^{(d)} | 1:1 | — | — | 1:1 |
| Amount of latex and polymer^{(e)} | 25 | 0 | 0 | 25 |

^{(a)}Nominal percentage of PCC (precipitated calcium carbonate) in the sheet
^{(b)}Latex sample as defined in Table 1
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

The data in Table 3 indicate that addition of a CL/AP system provides a dramatic improvement in paper properties. A comparison of Example 1 and Comparative Example 2 indicate that the CL/AP system results in a dry tensile strength increase of 33%, and a wet tensile strength increase of 200%. Porosity is decreased and both pick and abrasion resistance is improved while stiffness is unaffected.

TABLE 3
PERFORMANCE PROPERTIES

| | Example | | | |
|---|---|---|---|---|
| | 1 | Comp. Ex. 2 | Comp. Ex. 3 | 4 |
| Test^{(a)} | | | | |
| Dry Tensile (MD)^{(b,c)} | 12.8 | 9.4 | 16.1 | 11.8 |
| Dry Tensile (CD)^{(b,d)} | 4.7 | 3.3 | 5.7 | 4.6 |
| Wet Tensile (MD)^{(b,c)} | 1.7 | 0.5 | 0.66 | 1.5 |
| Wet Tensile (CD)^{(b,d)} | 0.7 | 0.2 | 0.3 | 0.7 |
| Porosity^{(e)} | 16.1 | 8.0 | 6.6 | 17.6 |
| Stiffness^{(f)} | 2.1 | 1.9 | 1.8 | 1.9 |
| Pick^{(g)} | 75.5 | 46.7 | 91.7 | 77.8 |
| Abrasion^{(h)} | 108.9 | 161.8 | 92.6 | 108.0 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost).

The paper properties of Example 1 are closer to that of Comparative Example 3 than Comparative Example 2. Thus, the sheet properties of the paper containing 30% filler are improved and more closely approximate those of a lower filler content sheet. In other words, the use of CL/AP, at this addition level, permits the use of an additional 10-15% filler (based on fiber) without loss of mechanical properties.

FIGS. 1 to 4 are plots of performance properties as a function of filler level. FIGS. 1 to 4, as noted, also demonstrate that the mechanical properties decrease as the level of filler increases. The data indicate that the CL/AP system improves paper performance. Specifically the data indicate that the performance properties of a sheet containing approximately 25% filler, when prepared with 25 lb/Ton of CL/AP, are essentially the same as that of a sheet containing 15% filler. Stated differently, the data indicate that while an increase in filler level from 15% (Comparative Example 3) to 30% (Comparative Example 2) results in a dramatic loss of performance, the addition of 25 lb/Ton of the latex/polymer system provides for a significant recovery of these performance properties. The CL/AP system provides improved performance at all levels of filler; the improvement is also observed for unfilled sheets (See Examples 40 to 42).

The data for Example 4 indicate that the use of a higher charge density polymer is also effective. Effective polymers can have any level of anionic charge.

### Examples 5 to 10

The effect of the total amount of CL/AP and the ratio of the two components were considered in Examples 5 to 10. Table 4 lists the key variables and the performance properties are shown in Table 5.

TABLE 4
PERFORMANCE DATA

Example

| | 5 | 6 | 7 | 8 | 9 | 10 |
|---|---|---|---|---|---|---|
| Filler (%)^{(a)} | 20 | 20 | 20 | 40 | 40 | 40 |
| Latex Sample^{(b)} | 8 | 8 | 8 | 8 | 8 | 8 |
| Polymer^{(c)} | A | A | A | A | A | A |
| Latex:Polymer | 1:1 | 3:1 | 3:1 | 1:1 | 3:1 | 3:1 |
| Ratio^{(d)} | | | | | | |
| Amount of latex | 25 | 25 | 40 | 25 | 25 | 40 |
| and polymer^{(e)} | | | | | | |

^{(a)}Nominal percentage of PCC (precipitated calcium carbonate) in the sheet
^{(b)}Latex sample as defined in Table 1
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

TABLE 5
PERFORMANCE DATA

| | Example | | | | | |
|---|---|---|---|---|---|---|
| Test^{(a)} | 5 | 6 | 7 | 8 | 9 | 10 |
| Dry Tensile (MD)^{(b,c)} | 17.7 | 17.1 | 19.5 | 10.5 | 7.7 | 8.9 |
| Dry Tensile (CD)^{(b,d)} | 6.2 | 6.0 | 6.6 | 3.4 | 3.0 | 3.1 |
| Wet Tensile (MD)^{(b,c)} | 2.2 | 2.4 | 3.3 | 1.5 | 1.3 | 1.7 |
| Wet Tensile (CD)^{(b,d)} | 0.9 | 1.0 | 1.3 | 0.6 | 0.5 | 0.7 |
| Porosity^{(e)} | 13.1 | 9.0 | 11.0 | 24.4 | 24.6 | 21.2 |
| Stiffness^{(f)} | 1.5 | 2.3 | 1.8 | 2.2 | 2.8 | 2.1 |
| Pick^{(g)} | 148.3 | 128.3 | 165.0 | 51.7 | 35.0 | 50.0 |
| Abrasion^{(h)} | 73.2 | 165.0 | 62.4 | 139.8 | 153.0 | 140.7 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

These data indicate, first, that the performance properties of the sheet deteriorate as the filler level is increased from 20 to 40% (compare Example 5 with 8 and Example 7 with 10). As the ratio of latex to polymer is increased from 1:1 to 3:1 (see Examples 5 to 10), the dry tensile strength decreases, while stiffness increases. The pick resistance and abrasion data indicate that the paper performance also decreases with increasing ratio of cationic latex to anionic polymer. These trends are independent of filler level. The effect on Gurley porosity is minimal.

As the amount of CL/AP is increased from 25 lb/ton to 40 lb/ton, wet and dry tensile strength increases, Taber stiffness decreases, and the paper performance, as determined by pick resistance and abrasion, also improve. The Gurley porosity shows a minimal decrease. These observations indicate that the amount of CL/AP system has an impact on the paper, with increasing level of CL/AP providing improving paper properties. Again, the trends are independent of filler level. Thus, additional amounts of the CL/AP material compensate for increased filler level. Stated another way, generally as filler content increases, paper properties deteriorate. However the addition of a CL/AP system mitigates the deterioration, where increasing levels of CL/AP permit either higher levels of filler with equal performance properties or improved paper properties at equal filler levels.

### Comparative Examples 11-15

Comparative Examples 11-15 considered the impact of filler level on the paper.

TABLE 6
PERFORMANCE DATA^{(a)}

| | Example | | | | |
|---|---|---|---|---|---|
| | Comp. | Comp. | Comp. | Comp. | Comp. |
| | Ex. 11 | Ex. 12 | Ex. 13 | Ex. 14 | Ex. 15 |
| Filler Level (%) | 0 | 15 | 20 | 30 | 40 |
| Dry Tensile | 32.6 | 16.1 | 13.8 | 9.4 | 5.9 |
| (MD)^{(b,c)} | | | | | |
| Dry Tensile | 11.3 | 5.7 | 4.8 | 3.3 | 2.1 |
| (CD)^{(b,d)} | | | | | |
| Wet Tensile | 1.0 | 0.7 | 0.6 | 0.5 | 0.4 |
| (MD)^{(b,c)} | | | | | |
| Wet Tensile | 0.4 | 0.3 | 0.3 | 0.2 | 0.2 |
| (CD)^{(b,d)} | | | | | |
| Porosity^{(e)} | 4.2 | 6.6 | 7.1 | 8.0 | 22.2 |
| Stiffness^{(f)} | 1.9 | 1.8 | 2.1 | 1.9 | 2.3 |
| Pick^{(g)} | 290.0 | 91.7 | 90.0 | 46.7 | 40.0 |
| Abrasion^{(h)} | 19.0 | 92.6 | 98.4 | 161.8 | 201.9 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

Mechanical and performance properties decline with increasing filler level is readily seen in Comparative Examples 11 to 15 (Table 6); these Examples are for paper that do not contain the CL/AP system. The data indicate that tensile strength, both wet and dry, decreases with increasing filler level, with, for example, the dry tensile in the machine direction decreasing for 32.6 lb/in width for an unfilled sheet to 13.8 lb/in width for a sheet containing 20% filler to 5.9 lb/in width for the sheet containing 40% filler. There are consistent changes in Gurley porosity, Taber stiffness, IGT pick resistance and Taber abrasion with increasing filler content. The observed changes with increasing filler content make a sheet less suitable for use in printing and writing applications.

The key parameters of the additive system that comprise the invention are the chemical composition and T_{g} (glass transition temperature) of the latex material, the chemical composition and charge density of the cationic polymer used to make the cationic latex, the chemical composition and anionic charge of the anionic polymer, the ratio of cationic polymer to anionic latex, the ratio of cationic latex to anionic polymer, and the total amount of additive (cationic latex and anionic polymer). The impact of these parameters is shown in Examples 16 to 39 and 43 to 46.

### Examples 16 to 18

It is believed that the chemical composition of the latex should have a minimal effect on the performance of the CL/AP system. That is to say, any latex, independent of chemical composition, can provide improved paper performance. Moreover, the T_{g} of the latex also has minimal impact on performance. That is to say, any water insoluble or water swellable latex, with any T_{g} can be used as the latex component of the CL/AP material. Examples 16 to 18 (Tables 7 and 8) are illustrative.

TABLE 7
EXAMPLES

| | Example | | |
|---|---|---|---|
| | 16 | 17 | 18 |
| Filler(%)^{(a)} | 30 | 30 | 30 |
| Latex sample^{(b)} | 2 | 8 | 5 |
| Polymer^{(c)} | A | A | A |
| Latex:Polymer ratio^{(d)} | 1:1 | 3:1 | 1:1 |
| Amount of latex and polymer^{(e)} | 10 | 10 | 10 |

^{(a)}Nominal percentage of PCC (precipitated calcium carbonate) in the sheet
^{(b)}Latex sample as defined in Table 1
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

The data suggest that there may be, at most, a small impact of T_{g} on pick resistance.

TABLE 8
PERFORMANCE DATA

| | Example | | |
|---|---|---|---|
| | 16 | 17 | 18 |
| Test^{(a)} | | | |
| Dry Tensile (MD)^{(b,c)} | 10.5 | 10.2 | 10.7 |
| Dry Tensile (CD)^{(b,d)} | 3.5 | 4.1 | 4.0 |
| Wet Tensile (MD)^{(b,c)} | 1.0 | 1.1 | 0.9 |
| Wet Tensile (CD)^{(b,d)} | 0.4 | 0.5 | 0.4 |
| Porosity^{(e)} | 13.8 | 12.8 | 14.3 |
| Stiffness^{(f)} | 2.1 | 1.8 | 1.9 |
| Pick^{(g)} | 33.0 | 53.0 | 43.0 |
| Abrasion^{(h)} | 142.0 | 137.0 | 138.0 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

### Examples 19 to 20

The chemical composition and charge density of the cationic polymer can, vary over a large range. Preferred cationic polymers are polyamidoamine-epichlorohydrin and polyamine-epichlorohydrin polymers, with the former most preferred. Similarly, the chemical composition and charge density of the anionic polymer can vary over a wide range, with good performance observed. Examples 19 and 20 illustrate the effect of charge density of the anionic polymer.

TABLE 9
EXAMPLES

Examples

| | 19 | 20 |
|---|---|---|
| Filler(%)^{(a)} | 30 | 30 |
| Latex sample^{(b)} | 8 | 8 |
| Polymer^{(c)} | A | B |
| Latex:Polymer ratio^{(d)} | 1:1 | 1:1 |
| Amount of latex and polymer^{(e)} | 25 | 25 |

^{(a)}Nominal percentage of PCC (precipitated calcium carbonate) in the sheet
^{(b)}Latex sample as defined in Table 1
^{(c)}Polymer A is 8 mol % acrylic acid and polymer B is 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

The data suggest that the charge density of the anionic polymer can show some variation, but that, overall, the performance properties are not highly dependent on this variable. The data support the view that the anionic polymer can be of any charge density.

TABLE 10
PERFORMANCE DATA

Example

| | 19 | 20 |
|---|---|---|
| Test^{(a)} | | |
| Dry Tensile (MD)^{(b,c)} | 12.9 | 11.9 |
| Dry Tensile (CD)^{(b,d)} | 4.7 | 4.6 |
| Wet Tensile (MD)^{(b,c)} | 1.7 | 1.5 |
| Wet Tensile (CD)^{(b,d)} | 0.7 | 0.7 |
| Porosity^{(e)} | 16.1 | 17.5 |
| Stiffness^{(f)} | 2.1 | 1.9 |
| Pick^{(g)} | 75.5 | 77.8 |
| Abrasion^{(h)} | 108.4 | 108.6 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

### Examples 21 to 26

The ratio of cationic polymer to anionic latex material used to make the cationic latex has a significant effect on paper properties. Examples 21 through 26, shown in Table 11, demonstrate the impact of this parameter on the invention.

TABLE 11
EXAMPLES

| | Examples | | | | | |
|---|---|---|---|---|---|---|
| | 21 | 22 | 23 | 24 | 25 | 26 |
| Filler (%)^{(a)} | 30 | 30 | 30 | 30 | 30 | 30 |
| Cationic Polymer:latex | 0.3:1 | 0.65:1 | 1:1 | 0.3:1 | 0.65:1 | 1:1 |
| Ratio^{(b)} | | | | | | |
| Polymer^{(c)} | A | A | A | B | B | B |
| Latex:Polymer ratio^{(d)} | 1:1 | 1:1 | 1:1 | 1:1 | 1:1 | 1:1 |
| Amount of latex and | 25 | 25 | 25 | 25 | 25 | 25 |
| polymer^{(e)} | | | | | | |

^{(a)}Nominal percentage of PCC (precipitated calcium carbonate) in the sheet
^{(b)}Cationic polymer to latex ratio
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

The data in Table 12 indicates that the ratio of cationic polymer to anionic latex can have a significant effect on paper performance properties. Increasing the relative amounts of cationic polymer has a small effect on certain parameters. The ratio of cationic polymer to anionic latex has a lesser impact than some of the other variables.

TABLE 12
PERFORMANCE DATA

| | Example | | | | | |
|---|---|---|---|---|---|---|
| Test^{(a)} | 21 | 22 | 23 | 24 | 25 | 26 |
| Dry Tensile (MD)^{(b,c)} | 12.0 | 12.9 | 12.7 | 11.5 | 11.8 | 13.1 |
| Dry Tensile (CD)^{(b,d)} | 4.5 | 4.7 | 4.3 | 4.4 | 4.6 | 4.4 |
| Wet Tensile (MD)^{(b,c)} | 1.2 | 1.7 | 1.8 | 1.9 | 1.5 | 1.8 |
| Wet Tensile (CD)^{(b,d)} | 0.6 | 0.7 | 0.8 | 0.5 | 0.7 | 0.8 |
| Porosity^{(e)} | 13.9 | 16.1 | 17.4 | 19.6 | 17.5 | 22.0 |
| Stiffness^{(f)} | 1.4 | 2.0 | 2.4 | 1.9 | 1.9 | 1.9 |
| Pick^{(g)} | 62.5 | 75.5 | 70.6 | 77.8 | 77.8 | 79.2 |
| Abrasion^{(h)} | 110.7 | 108.4 | 104.1 | 113.6 | 108.6 | 103.8 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

The data indicate that increasing the cationic polymer to latex ratio of the final cationic latex results in improved performance.

### Examples 27 to 33

Increasing the ratio of cationic latex (Sample 8 of Table 1) to anionic polymer, as demonstrated by Examples 27 through 33 (see Tables 13 and 14), indicates that while good performance is seen at all ratios, the range 0.3:1 to 3:1 is preferred and 1:1 to 3:1 is most preferred. It appears that there is an optimum value between 1:1 and 3:1.

TABLE 13
EXAMPLES

| | Examples | | | | | | |
|---|---|---|---|---|---|---|---|
| | 27 | 28 | 29 | 30 | 31 | 32 | 33 |
| Filler(%)^{(a)} | 30 | 30 | 30 | 30 | 30 | 30 | 30 |
| Polymer^{(b)} | A | B | A | B | A | B | A |
| Latex:Polymer Ratio^{(c)} | 0.3:1 | 0.3:1 | 1:1 | 1:1 | 3:1 | 3:1 | 10:1 |
| Amount of Latex and | 25 | 25 | 25 | 25 | 25 | 25 | 25 |
| Polymer^{(d)} | | | | | | | |

^{(a)}Nominal percentage of PCC (precipitated calcium carbonate) in the sheet
^{(b)}Polymer A is an acrylamide copolymer containing 8 mol % acrylic acid and polymer B is an acrylamide copolymer containing 20 mol % acrylic acid
^{(c)}Ratio of latex (Sample 8 of Table 1) to polymer added to slurry
^{(d)}Total amount of latex and polymer added to slurry in lbs/Ton (pounds of dry latex and polymer per ton of total dry paper)

TABLE 14
PERFORMANCE DATA

| | Example | | | | | | |
|---|---|---|---|---|---|---|---|
| Test^{(a)} | 27 | 28 | 29 | 30 | 31 | 32 | 33 |
| Dry Tensile (MD)^{(b,c)} | 11.3 | 11.0 | 12.6 | 12.1 | 11.0 | 12.2 | 11.1 |
| Dry Tensile (CD)^{(b,d)} | 4.0 | 4.1 | 4.6 | 4.5 | 4.4 | 4.4 | 4.2 |
| Wet Tensile (MD)^{(b,c)} | 1.0 | 0.9 | 1.6 | 1.5 | 1.7 | 1.9 | 1.7 |
| Wet Tensile (CD)^{(b,d)} | 0.5 | 0.4 | 0.7 | 0.7 | 0.8 | 0.8 | 0.8 |
| Porosity^{(e)} | 15.5 | 16.1 | 15.9 | 19.0 | 13.0 | 15.8 | 13.4 |
| Stiffness^{(f)} | 1.9 | 1.9 | 2.0 | 1.9 | 1.9 | 1.9 | 1.9 |
| Pick^{(g)} | 67.5 | 67.4 | 71.6 | 78.1 | 69.9 | 75.3 | 61.5 |
| Abrasion^{(h)} | 114 | 117.1 | 107.9 | 108.6 | 118.3 | 106.1 | 125.5 |

^{(a)}Test methods as described
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

### Examples 34 to 39

Examples 34 to 39 (see Tables 15 and 16) indicate that the amount of CL/AP system used has a significant effect on the performance properties of paper, with tensile strength, Gurley porosity and pick resistance increasing with increasing amounts of material, while Taber abrasion decreases with increasing levels.

TABLE 15
EXAMPLES

| | Example | | | | | |
|---|---|---|---|---|---|---|
| | 34 | 35 | 36 | 37 | 38 | 39 |
| Filler(%)^{(a)} | 30 | 30 | 30 | 30 | 30 | 30 |
| Polymer^{(b)} | A | B | A | B | A | B |
| Amount of Latex and Polymer^{(c)} | 10 | 10 | 25 | 25 | 40 | 40 |

^{(a)}Nominal percentage of PCC (precipitated calcium carbonate) in the sheet
^{(b)}Polymer A is an acrylamide copolymer containing 8 mol % acrylic acid and polymer B is an acrylamide copolymer containing 20 mol % acrylic acid
^{(c)}Total amount of latex and polymer added to slurry in lbs/Ton (pounds of dry latex and polymer per ton of total dry paper)

TABLE 16
PERFORMANCE DATA

| | Example | | | | | |
|---|---|---|---|---|---|---|
| Test^{(a)} | 34 | 35 | 36 | 37 | 38 | 39 |
| Dry Tensile (MD)^{(b,c)} | 10.7 | 11.7 | 11.7 | 11.8 | 12.6 | 12.9 |
| Dry Tensile (CD)^{(b,d)} | 3.9 | 4.2 | 4.4 | 4.4 | 4.5 | 4.7 |
| Wet Tensile (MD)^{(b,c)} | 0.9 | 1.0 | 1.5 | 1.4 | 1.8 | 1.8 |
| Wet Tensile (CD)^{(b,d)} | 0.4 | 0.4 | 0.7 | 0.6 | 0.8 | 0.8 |
| Porosity^{(e)} | 13.3 | 16.8 | 14.7 | 17.6 | 17.7 | 16.9 |
| Stiffness^{(f)} | 1.9 | 1.9 | 1.9 | 1.9 | 2.0 | 2 |
| Pick^{(g)} | 49.7 | 55.3 | 68.3 | 74.9 | 69.3 | 75.6 |
| Abrasion^{(h)} | 134.5 | 121.5 | 114.9 | 110.0 | 109.4 | 103.3 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

### Examples 40 to 42

Comparative Example 40 and Examples 41 and 42, shown in Tables 17 and 18, illustrate the impact of the CL/AP system on an unfilled sheet.

TABLE 17
EXAMPLES

| | Examples | | |
|---|---|---|---|
| | Comp. Ex. 40 | 41 | 42 |
| Filler (%)^{(a)} | 0 | 0 | 0 |
| Latex Sample^{(b)} | — | 8 | 8 |
| Polymer^{(c)} | — | A | B |
| Latex:Polymer Ratio^{(d)} | — | 1:1 | 1:1 |
| Amount of Latex and Polymer^{(e)} | — | 25 | 25 |

^{(a)}Nominal percentage of PCC (precipitated calcium carbonate) in the sheet
^{(b)}Latex sample as defined in Table 1
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton (pounds of dry latex and polymer per ton of total dry paper)

The data indicate that addition of a CL/AP system improves the tensile strength of the sheet increases stiffness and provides pick and abrasion resistance.

TABLE 18
PERFORMANCE DATA

| | Examples | | |
|---|---|---|---|
| | Comp. Ex. 40 | 41 | 42 |
| Test^{(a)} | | | |
| Dry Tensile (MD)^{(b,c)} | 32.6 | 33.9 | 34.2 |
| Dry Tensile (CD)^{(b,d)} | 11.3 | 12.7 | 12.72 |
| Wet Tensile (MD)^{(b,c)} | 1.0 | 3.3 | 4.0 |
| Wet Tensile (CD)^{(b,d)} | 0.4 | 1.5 | 1.8 |
| Porosity^{(e)} | 4.2 | 8.4 | 8.5 |
| Stiffness^{(f)} | 1.9 | 2.4 | 2.8 |
| Pick^{(g)} | 290 | 350 | 400 |
| Abrasion^{(h)} | 19.1 | 14.6 | 14.9 |

^{(a)}Test methods as described above
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

The data again indicate, first, that the unfilled sheet uses the higher tensile strength and best combination of properties. Second, the data demonstrate the efficacy of the CL/AP system.

### Examples 43 to 46

Comparative Example 43 and Examples 45 and 46, shown in Tables 19 and 20, illustrate the impact of the use level of the CL/AP system on performance. The Examples cover a range up 40 lb/Ton.

TABLE 19
EXAMPLES

| | Examples | | | |
|---|---|---|---|---|
| | Comp. Ex. 43 | 44 | 45 | 46 |
| Filler (%) | 30 | 30 | 30 | 30 |
| Sample^{(b)} | — | 8 | 8 | 8 |
| Polymer^{(a)} | — | A | A | A |
| Latex:Polymer Ratio^{(d)} | — | 1:1 | 1:1 | 1:1 |
| Amount of Latex and Polymer^{(e)} | 0 | 10 | 25 | 40 |

^{(a)}Nominal percentage of PCC (precipitated calcium carbonate) in the sheet
^{(b)}Latex sample as defined in Table 1
^{(c)}Polymer A is an acrylamide copolymer containing 8 mol % acrylic acid and polymer B is an acrylamide copolymer containing 20 mol % acrylic acid
^{(d)}Ratio of latex to polymer added to slurry
^{(e)}Total amount of latex and polymer added to slurry in lbs/Ton

The data in Table 20 indicate that paper properties improve with additional amounts of the CL/AP system used. The amount of the CL/AP system has a major influence on paper properties.

TABLE 20
PERFORMANCE DATA

| | Examples | | | |
|---|---|---|---|---|
| | Comp. Ex. 43 | 44 | 45 | 46 |
| Test | | | | |
| Dry Tensile (MD)^{(b,c)} | 9.4 | 11.0 | 12.7 | 12.9 |
| Dry Tensile (CD)^{(b,d)} | 3.2 | 4.0 | 4.7 | 4.9 |
| Wet Tensile (MD)^{(b,c)} | 0.5 | 1.0 | 1.7 | 2.6 |
| Wet Tensile (CD)^{(b,d)} | 0.2 | 0.4 | 0.7 | 1.1 |
| Porosity^{(e)} | 8.0 | 14.1 | 16.1 | 17.6 |
| Stiffness^{(f)} | 1.9 | 1.8 | 2.1 | 2.3 |
| Pick^{(g)} | 46.7 | 59.2 | 75.5 | 82.5 |
| Abrasion^{(h)} | 161.8 | 130.7 | 108.3 | 92.1 |

^{(a)}Test methods as described
^{(b)}Tensile strength in lb/in width
^{(c)}MD is machine direction
^{(d)}CD is cross direction
^{(e)}Gurley porosity in sec/100 cc
^{(f)}Taber stiffness in gm-cm
^{(g)}IGT pick resistance in cm/sec
^{(h)}Taber abrasion (mg lost)

### Examples 47-54

These Examples show a comparison between paper made using the CL/AP system and paper made without using the CL/AP system.

TABLE 21
PERFORMANCE DATA

| | Example | | | | | | | |
|---|---|---|---|---|---|---|---|---|
| | 47 | 48 | 49 | 50 | 51 | 52 | 53 | 54 |
| Filler Level (%)^{(a)} | 0 | 0 | 15 | 15 | 30 | 30 | 40 | 40 |
| Additive System^{(b)} | N | Y | N | Y | N | Y | N | Y |
| Dry Tensile (MD)^{(c,d)} | 23.56 | 29.71 | 13.13 | 18.02 | 7.57 | 11.37 | 5.27 | 8.38 |
| Wet Tensile MD^{(c,d)} | 0.93 | 3.09 | 0.57 | 1.69 | 0.42 | 1.11 | 0.33 | 1.00 |
| Taber Stiffness^{(e)} | 1.18 | 1.23 | 1.05 | 0.97 | 0.65 | 0.64 | 0.64 | 0.71 |
| Taber Abrasion^{(f)} | 17.0 | 20.0 | 89.4 | 56.4 | 169.5 | 122.9 | 177.8 | 148.4 |

^{(a)}Filler content
^{(b)}Use of CL/AP additive system (Yes or No) CL/AP system used was 25 lb/T of a 2:1 ratio of latex No. 1 (of Table 1) and polymer A
^{(c)}Tensile Strength is lb/in width
^{(d)}MD is machine direction
^{(e)}Taber stiffness in gm-cm
^{(f)}Taber abrasion (mg lost)

Table 21 provides data regarding paper made without the use of the CL/AP system. Comparative Examples 47, 49, 51 and 53 are papers containing different levels of filler. Examples 48, 50, 52 and 54 are corresponding examples made with the CL/AP system. The data are part of a separate experiment utilizing different cationic latex than was used in the other examples.

The data indicates that as the filler level was increased, there is a continuous decline in the mechanical proportions of the sheet. Use of the CL/AP system resulted in an increase in these properties.

What is claimed is:

1. An additive system comprising a combination of a cationic latex and an anionic polymer, wherein the cationic latex comprises a cationic polymer absorbed onto a surface of an anionic and/or nonionic latex particle.

2. The additive system according to claim 1 wherein the cationic polymer comprises polyamidoamine-epihalohydrin resins, cationic functionalized polyacrylamides, acrylamide-based crosslinkable polymers, polyamines, polyimines, polymers or copolymers of diallyldimethylammonium chloride and polyamines, epichlorohydrin resins and combinations thereof.

3. The additive system according to claim 1, wherein the cationic polymer comprises polyamidoamine-epihalohydrin resins and cationic functionalized polyacrylamides.

4. The additive system according to claim 1, wherein the anionic polymer is a homopolymer or a copolymer.

5. The additive system according to claim 4, wherein the copolymer comprises at least one anionic monomer and at least one nonionic monomer.

6. The additive system according to claim 1, wherein the anionic polymer comprises at least one anionic monomer.

7. The additive system according to claim 6, wherein the at least one anionic monomer comprises free acids and salts of acrylic acid and combinations thereof, styrene sulfonate, maleic acid, itaconic acid, methacrylic acid, 2-acrylamido-2-methyl-1-propane sulfonic acid, vinyl sulfonic acid, vinylphosphonic acid, acrylamidoglycolic acid and combinations thereof.

8. The additive system according to claim 5, wherein the at least one nonionic monomer comprises acrylamide, methacrylamide N-alkylacrylamides; N,N-dialkylacrylamide; methyl acrylate; methyl methacrylate acrylonitrile; N-vinyl methylacetamide; N-vinyl methyl formamide; vinyl acetate; N-vinyl pyrrolidone, alkyl acrylates, alkyl methacrylates, alkyl acryamides, alkyl methacrylamides, and alkyloxylated acrylates and methacrylates, and alkyl polyethyleneglycol methacrylates.

9. The additive system according to claim 5, wherein the at least one anionic monomer is acrylic acid and the at least one nonionic monomer is an acrylamide.

10. The additive system according to claim 1, wherein the cationic latex and anionic polymer are in a ratio ranging from about 0.03:1 to about 10:1.

11. The additive system according to claim 10, wherein the cationic latex and anionic polymer are in a ratio ranging from about 0.05:1 to about 4:1.

12. The additive system according to claim 11, wherein the cationic latex and anionic polymer are in a ratio of about 1:1 to about 3:1

13. The additive system according to claim 12, wherein the cationic latex and anionic polymer are in a ratio of about 1:1 to about 2:1

14. A process for making paper comprising:
(a) producing an aqueous slurry of cellulosic fibers; and
(b) adding the additive system of claim 1 comprising:
(i) adding a cationic latex to the aqueous slurry, and
(ii) adding an anionic polymer to the aqueous slurry.

15. The process according to claim 14, further comprising (c) forming a paper sheet.

16. The process according to claim 14, wherein the additive system is added to the aqueous slurry in an amount ranging from about 5 lbs/ton of pulp to about 100 lbs/ton of dry paper.

17. The process according to claim 16, wherein the additive system is added to the aqueous slurry in an amount ranging from about 15 lb/ton of pulp to about 50 lb/ton of dry paper.

18. The process according to claim 17, wherein the additive system is added to the aqueous slurry in an amount ranging from about 20 lb/ton of pulp to about 40 lb/ton of dry paper.

19. The process according to claim 1, wherein aqueous slurry comprises a filler.

20. The process according to claim 19, wherein the filler comprises a mineral composition.

21. The process according to claim 20, wherein the mineral composition comprises an alumina, clay, calcium sulfate, diatomaceous silica, silicates, calcium carbonate, silicas, silicoaluminates, talc, and titanium dioxide.

22. The process according to claim 19, wherein the filler is present in an amount ranging from about 5 wt-% to about 60 wt-% of the aqueous slurry.

23. The process according to claim 22, wherein the filler is present in an amount ranging from about 15 wt-% to about 50 wt-%.

24. The process according to claim 23, wherein the filler is present in an amount of about 20 wt-% to about 40 wt-% of the aqueous slurry.

25. The process according to claim 24, wherein the filler is present in an amount of about 25 wt-% to about 40 wt-% of the aqueous slurry.

26. An aqueous slurry of cellulose fibers comprising the additive system of claim 1.

27. The aqueous slurry of cellulose fibers according to claim 26, further comprising a filler.

28. A paper sheet made according to the process of claim 14

29. A paper sheet comprising the additive system of claim 1.
